(19) United States
(12) Patent Application Publication
(10) Pub. No.: US 2014/0279009 A1
(43) Pub. Date: Sep. 18, 2014

(54) SELF-SERVICE INTERCEPT ON OR OFF PREMISE

(71) Applicant: BANK OF AMERICA CORPORATION, Charlotte, NC (US)

(72) Inventors: David M. Grigg, Rock Hill, NC (US); Matthew A. Calman, Charlotte, NC (US); Susan Smith Thomas, Gastonia, NC (US)

(73) Assignee: Bank of America Corporation, Charlotte, NC (US)

(21) Appl. No.: 13/828,969

(22) Filed: Mar. 14, 2013

(51) Int. Cl. G06Q 30/02

(52) U.S. Cl. CPC G06Q 30/0261
USPC 705/14.58

(57) ABSTRACT

Embodiments of the invention are directed to systems, methods and computer program products for transmitting an offer to a user associated with an account. An exemplary apparatus is configured to: determine, based on geolocation information associated with a mobile device associated with the user, whether the mobile device is within a predetermined distance of a reference location; in response to determining the mobile device is within the predetermined distance of the reference location, transmit an offer to the mobile device, wherein the offer is associated with a product or a service, and wherein the offer has been previously communicated to the user; and provide an option for the user to accept the offer via the mobile device.

### BACKGROUND

Offers associated with products or services may be communicated to potential customers, but these potential customers may ignore these offers. There is a need to remind these potential customers about these offers.

### BRIEF SUMMARY

In some embodiments, an apparatus is provided for transmitting an offer to a user associated with an account. The apparatus comprises a memory; a processor; and a module stored in the memory, executable by the processor, and configured to: determine, based on geolocation information associated with a mobile device associated with the user, whether the mobile device is within a predetermined distance of a reference location; in response to determining the mobile device is within the predetermined distance of the reference location, transmit an offer to the mobile device, wherein the offer is associated with a product or a service, and wherein the offer has been previously communicated to the user; and provide an option for the user to accept the offer via the mobile device.

In some embodiments, the product or the service is associated with a financial institution.

In some embodiments, the product or the service is associated with a merchant.

In some embodiments, the geolocation information comprises a geographical location.

In some embodiments, the geolocation information comprises a network location.

In some embodiments, the reference location comprises at least one of a branch office associated with a financial institution, an automated teller machine (ATM), or an advertisement hoarding.

In some embodiments, the reference location comprises a merchant's premises.

In some embodiments, the offer was previously communicated to the user via at least one of a social network account, an email account, or a text message account.

In some embodiments, the offer previously communicated to the user was declined by the user.

In some embodiments, the offer previously communicated to the user was neither accepted nor declined by the user.

In some embodiments, the offer is associated with an expiration period.

In some embodiments, the offer is transmitted via at least one a social network account, an email account, or a text message account.

In some embodiments, the module is further configured to transmit to the user an incentive associated with the offer, wherein the incentive is provided to the user if at least one of the user accepts the offer within a predetermined period of time or the user accepts the offer via the mobile device.

In some embodiments, the user accepts the offer via a channel other than the mobile device.

In some embodiments, the offer can be accepted by the user if the mobile device is within the predetermined distance of the reference location, and wherein the offer is deactivated if the mobile device is not within the predetermined distance of the reference location.

In some embodiments, the offer is communicated to the user via at least one of a human agent or a virtual agent.

In some embodiments, the offer is based on at least one of account information or user information associated with the user.

In some embodiments, the offer is associated with a discount or rebate on the product or the service.

In some embodiments, a method is provided for transmitting an offer to a user associated with an account. The method comprises: determining, based on geolocation information associated with a mobile device associated with the user, whether the mobile device is within a predetermined distance of a reference location; in response to determining the mobile device is within the predetermined distance of the reference location, transmitting an offer to the mobile device, wherein the offer is associated with a product or a service, and wherein the offer has been previously communicated to the user; and providing an option for the user to accept the offer via the mobile device.

In some embodiments, a computer program product is provided for transmitting an offer to a user associated with an account. The computer program product comprises a non-transitory computer-readable medium comprising a set of codes for causing a computer to: determine, based on geolocation information associated with a mobile device associated with the user, whether the mobile device is within a predetermined distance of a reference location; in response to determining the mobile device is within the predetermined distance of the reference location, transmit an offer to the mobile device, wherein the offer is associated with a product or a service, and wherein the offer has been previously communicated to the user; and provide an option for the user to accept the offer via the mobile device.

### BRIEF DESCRIPTION OF THE DRAWINGS

Having thus described embodiments of the invention in general terms, reference will now be made to the accompanying drawings, where:

FIG. 1 is a flowchart illustrating a general process flow for transmitting an offer to a user associated with an account, in accordance with embodiments of the present invention; and

FIG. 2 is a block diagram illustrating technical components of a system for implementing the various processes described herein, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for transmitting an offer to a user associated with an account. The invention enables an entity to send targeted offers to a user based on geolocation information associated with the user's mobile device. Therefore, the present invention enables an entity to get the user's attention at a time when the user is likely to read the offer and transmit a response to the offer. In some embodiments, a user may pre-register with the entity so that the user can receive offers (and/or other information) from the entity (e.g., via the user's mobile device or other methods such as email, social network, or financial institution network).

In some embodiments, an “entity” may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In still other embodiments, the entity may be the merchant associated with an offer. In some embodiments, the “user” may be a customer (e.g., an account holder or a person who has an account (e.g., banking account, credit account, or the like) at the entity) or a potential customer who does not yet have an account associated with the entity. The invention enables a user to receive service from the entity via a mobile device either on the premises of the entity (e.g., a branch office) or off the premises of the entity. The service may comprise providing an offer to the user and enabling a user to accept or decline the offer.

In some embodiments, an offer as described herein is an offer associated with a product or service provided by the entity. In other embodiments, an offer is associated with a product or service provided by a third-party merchant. An entity (e.g., a financial institution) may send an offer to a user (e.g., an account holder). For example, the offer may be a discount or rebate on a product or service. The offer may be presented to the user via at least one of the user's electronic banking account (e.g., online banking account, mobile banking account on a portable mobile communication device, or the like), the user's social network account, email, or text message. In some embodiments, the user may select an option associated with the presented offer to accept the offer. In some embodiments, the user may select an option to be reminded of the offer again at a later time, where the later time may be specified by the user. When the user accepts the offer, the user receives the benefit associated with the offer. However, a user may just ignore the offer. Therefore, there is a need to remind the user of the offer.

Therefore, the apparatus described herein transmits the same offer (e.g., the offer previously communicated to the user) when the apparatus determines that the user's mobile device is at or within a predetermined distance to a reference location associated with the entity (or the merchant associated with the offer). In some embodiments, the apparatus transmits the same offer to the user (e.g., the user's mobile device) regardless of whether the user's mobile device is at or within a predetermined distance to the reference location associated with the entity. In some embodiments, the apparatus transmits the offer if the user previously selected an option to be reminded of the offer at a later time. In other embodiments, the apparatus transmits the offer to the user regardless of whether the user selected an option to be reminded of the offer at a later time.

The reference location may be at least one of a branch office of the entity, an automated teller machine (ATM), an advertising hoarding associated with the entity, or the like. As described herein, the offer is an outstanding offer, i.e., the offer was previously communicated to the user and the user has neither accepted nor declined the offer and the period for accepting the offer is still open (e.g., the offer has not yet expired). In some embodiments, the offer may be an offer that was previously declined or rejected by the user. In some embodiments, the user may be reminded of the offer when the user executes a transaction at a branch office associated with the entity. For example, a human or virtual agent at the branch office may communicate a reminder about the offer to the user. As another example, an ATM may remind the user of the offer either prior to, during, or after the user executes a transaction at an ATM. The user may be reminded of the offer multiple times and via multiple channels (e.g., ATM, human agent, virtual agent, text message, social networking message, financial institution network message, email, or the like) while the offer is still open (e.g., the offer has not yet expired). In some embodiments, the user may specify how many times that the user wishes to be reminded (e.g., four times) during a predetermined period. As an example, a user's Certificate of Deposit (CD) may be expiring soon, and the offer is associated with a rate for rolling the CD for a subsequent period. In some embodiments, the reminder offer transmitted to the user is a better offer (e.g., a better rate, a bigger discount, or the like) than the original offer transmitted to the user.

In some embodiments, when the user is reminded about the offer, the entity presents the user with an incentive to accept the offer within a predetermined period of time or via the channel through which the offer was reminded of the offer. For example, if the user is reminded of the offer via a message communicated to the user's mobile device, the user may receive an incentive (e.g., a bonus rate for rolling the CD) if the user accepts the offer by responding to the offer via the user's mobile device and/or if the user accepts the offer within a certain period that is specified in the offer. In some embodiments, the user may accept the offer via a different channel (e.g., via ATM) or via phone even though the user received the offer via a mobile device.

In some embodiments, the user may accept the offer via the user's mobile device if the user is located at the reference location or within the predetermined distance to the reference location described herein. If the user is not located at the reference location or within the predetermined distance to the reference location, the user may not be able to accept the offer via the user's mobile device. In some embodiments, the user may not be able to view the offer on the mobile device once the user is no longer located at or within the predetermined distance to the reference location.

The offer transmitted to the user (e.g., the original offer, the reminder offer, or the like) may be based on at least one of geolocation information associated with the user's mobile device, account information associated with the user's account, or the user information associated with the user. The account information comprises a transaction history (e.g., during a predetermined period) associated with the account. The transaction history comprises at least one of a type of a transaction, a frequency associated with the transaction, an amount associated with the transaction, or a merchant associated with the transaction. In some embodiments, the offer may be based on a transaction being executed by the user on the mobile device, at an ATM, at a branch office, or the like. The user information associated with a user comprises personal information associated with at least one of the user, a family member of the user, or a friend of the user. As described herein, the personal information comprises at least one of demographic information, salary information, contact information, residence address information, job profile information, education information, or social network information.

Referring now to FIG. 1, a general process flow 100 is provided for transmitting an offer to a user of an account. At block 110, the method comprises determining, based on geolocation information associated with the mobile device associated with the user, whether the mobile device is within a predetermined distance of a reference location. At block 120, the method comprises in response to determining the mobile device is within the predetermined distance of the reference location, transmitting an offer to the mobile device, wherein the offer is associated with a product or a service, and wherein the offer has been previously communicated to the user. At block 130, the method comprises providing an option for the user to accept the offer via the mobile device. As used herein, geolocation information may also be referred to as location information, positioning information, position information, global positioning information, network location, or the like. Geolocation information associated with the user refers to geographical or network information associated with a location of the user's mobile device (e.g., mobile phone, tablet, watch, laptop, automobile, other portable computing device, or the like). In some embodiments, a reference location may be a reference geographical area (e.g., the area associated with a branch office of the entity).

As used herein, geolocation information includes global positioning information. Global positioning information may include any information collected from methods, systems, apparatus, computer programs, or the like, involving locating a device's position relative to satellites, fixed locations, beacons, transmitters, the apparatus, system, or server described herein, or the like. In some instances, global positioning information may be collected from a global positioning system (GPS) device, such as a navigation system. Such a navigation system may be, but is not limited to, hardware and/or software that is part of a mobile phone, smartphone, personal digital assistant (PDA), automobile, watch, tablet, portable computing device, or a commercially available personal navigation system. The amount, nature and type of the global positioning information that is collected may depend on the entity's relationship with the user and the amount of information that the user has authorized the entity to collect or capture. In some embodiments, the global positioning information will be snapshots of the user's location at different times. For example, a snapshot of the user's location may be collected each time the GPS software, navigation system or application is activated. As another example, a snapshot of the user's location may be collected each time a user is located within the premises of an entity (e.g., a branch office, an automated teller machine ATM) or within a predetermined distance of the entity. As another example, a snapshot of the user's location may be collected each time a user executes a transaction at the entity (e.g., via the user's mobile device) or executes a transaction via the user's mobile device (e.g., executes a banking transaction, logs into the user's account, or the like). The geolocation information may also include the destination entered by the user, recent searches for locations, attractions, addresses, or the like. In other instances, the geolocation information may be a route (e.g., a route to a particular merchant) being provided to the user, including destination, route, alternate routes, anticipated time of arrival, or the like. In other embodiments, geolocation information may comprise a network location associated with a user (e.g., an Internet Protocol (IP) address, a device address, a location of a telecommunication tower located close to or closest to or within a predetermined distance from the user's mobile device, or the like). In some embodiments, a geolocation may refer to a location in relation to an apparatus or other computing device. In some embodiments, a user may need to register the user's mobile device with the entity in order to enable the entity to capture geolocation information associated with the mobile device. Therefore, a user may need to opt-in to a program that enables capture of geolocation information. As used herein, geolocation information associated with a user refers to geolocation information associated with the user's mobile device.

Referring now to FIG. 2, FIG. 2 presents an exemplary block diagram of the system environment 200 for implementing any of the process flows described herein, in accordance with embodiments of the present invention. As illustrated, the system environment 200 includes a network 210, a system 230, and a user input system 240. Also shown in FIG. 2 is a user 245 of the user input system 240. The user input system 240 may be a mobile device (e.g., a portable mobile communication device) described herein. The user 245 may be a person (e.g., an account holder) who uses the user input system 240 to execute a user application 247. The system 230 may be the server or apparatus described herein. The user application 247 and/or the system application 237 may incorporate one or more parts of the process flow 100 or any other function described herein. The user 245 may use the user input system 240 to view an offer, activate or activate an offer, decline the offer, store the offer, or the like. The system 230 may receive geolocation information associated with the user, process the geolocation information to determine offers to transmit to the user, or the like.

As shown in FIG. 2, the system 230, and the user input system 240 are each operatively and selectively connected to the network 210, which may include one or more separate networks. In addition, the network 210 may include a local area network (LAN), a wide area network (WAN), and/or a global area network (GAN), such as the Internet. The network may also include a mobile telecommunication network. It will also be understood that the network 210 may be secure and/or unsecure and may also include wireless and/or wireline and/or optical interconnection technology.

The user input system 240 may include any computerized apparatus that can be configured to perform any one or more of the functions of the user input system 240 described and/or contemplated herein. For example, the user 245 may use the user input system 240 to transmit and/or receive information or commands to and from the system 230. In some embodiments, for example, the user input system 240 may include a personal computer system, a mobile computing device, a personal digital assistant, a mobile phone, a network device, and/or the like. As illustrated in FIG. 2, in accordance with some embodiments of the present invention, the user input system 240 includes a communication interface 242, a processor 244, a memory 246 having an user application 247 stored therein, and a user interface 249. In such embodiments, the communication interface 242 is operatively and selectively connected to the processor 244, which is operatively and selectively connected to the user interface 249 and the memory 246. In some embodiments, the user 245 may use the user application 247 to execute processes described with respect to the process flows described herein.

Each communication interface described herein, including the communication interface 242, generally includes hardware, and, in some instances, software, that enables the user input system 240, to transport, send, receive, and/or otherwise communicate information to and/or from the communication interface of one or more other systems on the network 210. For example, the communication interface 242 of the user input system 240 may include a wireless transceiver, modem, server, electrical connection, and/or other electronic device that operatively connects the user input system 240 to another system such as the system 230. The wireless transceiver may include a radio circuit to enable wireless transmission and reception of information.

Each processor described herein, including the processor 244, generally includes circuitry for implementing the audio, visual, and/or logic functions of the user input system 240. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 247 of the memory 246 of the user input system 240.

Each memory device described herein, including the memory 246 for storing the user application 247 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 2, the memory 246 includes the user application 247. In some embodiments, the user application 247 includes an interface for communicating with, navigating, controlling, configuring, and/or using the user input system 240. In some embodiments, the user application 247 includes computer-executable program code portions for instructing the processor 244 to perform one or more of the functions of the user application 247 described and/or contemplated herein. In some embodiments, the user application 247 may include and/or use one or more network and/or system communication protocols.

Also shown in FIG. 2 is the user interface 249. In some embodiments, the user interface 249 includes one or more output devices, such as a display and/or speaker, for presenting information to the user 245. In some embodiments, the user interface 249 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 245. In some embodiments, the user interface 249 includes the input and display devices of a mobile device, which are operable to receive and display information.

FIG. 2 also illustrates a system 230, in accordance with an embodiment of the present invention. The system 230 may include any computerized apparatus that can be configured to perform any one or more of the functions of the system 230 described and/or contemplated herein. In accordance with some embodiments, for example, the system 230 may include a computer network, an engine, a platform, a server, a database system, a front end system, a back end system, a personal computer system, and/or the like. Therefore, the system 230 may be a server, apparatus, or other computing device as described herein. The system may be associated with (e.g., managed by) at least one of a financial institution, a merchant, any other entity that may not be associated with the financial institution or the merchant, an acquirer, an issuer, a card network entity, a user of an account, or the like. In some embodiments, such as the one illustrated in FIG. 2, the system 230 includes a communication interface 232, a processor 234, and a memory 236, which includes a system application 237 and a datastore 238 stored therein. As shown, the communication interface 232 is operatively and selectively connected to the processor 234, which is operatively and selectively connected to the memory 236.

It will be understood that the system application 237 may be configured to implement any one or more portions of the various user interfaces and/or process flow described herein. The system application 237 may interact with the user application 247. It will also be understood that, in some embodiments, the memory includes other applications. It will also be understood that, in some embodiments, the system application 237 is configured to communicate with the datastore 238, the user input system 240, or the like.

It will be further understood that, in some embodiments, the system application 237 includes computer-executable program code portions for instructing the processor 234 to perform any one or more of the functions of the system application 237 described and/or contemplated herein. In some embodiments, the system application 237 may include and/or use one or more network and/or system communication protocols.

In addition to the system application 237, the memory 236 also includes the datastore 238. As used herein, the datastore 238 may be one or more distinct and/or remote datastores. In some embodiments, the datastore 238 is not located within the system and is instead located remotely from the system. In some embodiments, the datastore 238 stores information or data described herein.

It will be understood that the datastore 238 may include any one or more storage devices, including, but not limited to, datastores, databases, and/or any of the other storage devices typically associated with a computer system. It will also be understood that the datastore 238 may store information in any known way, such as, for example, by using one or more computer codes and/or languages, alphanumeric character strings, data sets, figures, tables, charts, links, documents, and/or the like. Further, in some embodiments, the datastore 238 may include information associated with one or more applications, such as, for example, the system application 237. It will also be understood that, in some embodiments, the datastore 238 provides a substantially real-time representation of the information stored therein, so that, for example, when the processor 234 accesses the datastore 238, the information stored therein is current or substantially current.

It will be understood that the embodiment of the system environment illustrated in FIG. 2 is exemplary and that other embodiments may vary. As another example, in some embodiments, the system 230 includes more, less, or different components. As another example, in some embodiments, some or all of the portions of the system environment 200 may be combined into a single portion. Likewise, in some embodiments, some or all of the portions of the system 230 may be separated into two or more distinct portions.

In addition, the various portions of the system environment 200 may be maintained for and/or by the same or separate parties. It will also be understood that the system 230 may include and/or implement any embodiment of the present invention described and/or contemplated herein. For example, in some embodiments, the system 230 is configured to implement any one or more of the embodiments of any process flow described herein. Additionally, the system 230 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for transmitting an offer to a user associated with an account, the apparatus comprising:
a memory;
a processor; and
a module stored in the memory, executable by the processor, and configured to:
determine, based on geolocation information associated with a mobile device associated with the user, whether the mobile device is within a predetermined distance of a reference location;
in response to determining the mobile device is within the predetermined distance of the reference location, transmit an offer to the mobile device, wherein the offer is associated with a product or a service, and wherein the offer has been previously communicated to the user; and
provide an option for the user to accept the offer via the mobile device.

2. The apparatus of claim 1, wherein the product or the service is associated with a financial institution.

3. The apparatus of claim 1, wherein the product or the service is associated with a merchant.

4. The apparatus of claim 1, wherein the geolocation information comprises a geographical location.

5. The apparatus of claim 1, wherein the geolocation information comprises a network location.

6. The apparatus of claim 1, wherein the reference location comprises at least one of a branch office associated with a financial institution, an automated teller machine (ATM), or an advertisement hoarding.

7. The apparatus of claim 1, wherein the reference location comprises a merchant's premises.

8. The apparatus of claim 1, wherein the offer was previously communicated to the user via at least one of a social network account, an email account, or a text message account.

9. The apparatus of claim 1, wherein the offer previously communicated to the user was declined by the user.

10. The apparatus of claim 1, wherein the offer previously communicated to the user was neither accepted nor declined by the user.

11. The apparatus of claim 1, wherein the offer is associated with an expiration period, and wherein the offer is transmitted via at least one a social network account, an email account, or a text message account.

12. The apparatus of claim 1, wherein the module is configured to receive permission from the user to receive the geolocation information.

13. The apparatus of claim 1, wherein the module is further configured to transmit to the user an incentive associated with the offer, wherein the incentive is provided to the user if at least one of the user accepts the offer within a predetermined period or the user accepts the offer via the mobile device.

14. The apparatus of claim 1, wherein the user accepts the offer via a channel other than the mobile device.

15. The apparatus of claim 1, wherein the offer can be accepted by the user if the mobile device is within the predetermined distance of the reference location, and wherein the offer is deactivated if the mobile device is not within the predetermined distance of the reference location.

16. The apparatus of claim 1, wherein the offer is communicated to the user via at least one of a human agent or a virtual agent.

17. The apparatus of claim 1, wherein the offer is based on at least one of account information or user information associated with the user.

18. The apparatus of claim 1, wherein the offer is associated with a discount or rebate on the product or the service.

19. A method for transmitting an offer to a user associated with an account, the method comprising:
determining, based on geolocation information associated with a mobile device associated with the user, whether the mobile device is within a predetermined distance of a reference location;
in response to determining the mobile device is within the predetermined distance of the reference location, transmitting an offer to the mobile device, wherein the offer is associated with a product or a service, and wherein the offer has been previously communicated to the user; and
providing an option for the user to accept the offer via the mobile device.

20. A computer program product for transmitting an offer to a user associated with an account, the computer program product comprising:
a non-transitory computer-readable medium comprising a set of codes for causing a computer to:
determine, based on geolocation information associated with a mobile device associated with the user, whether the mobile device is within a predetermined distance of a reference location;
in response to determining the mobile device is within the predetermined distance of the reference location, transmit an offer to the mobile device, wherein the offer is associated with a product or a service, and wherein the offer has been previously communicated to the user; and
provide an option for the user to accept the offer via the mobile device.
